(19) United States
(12) Patent Application Publication
(10) Pub. No.: US 2009/0275321 A1
(43) Pub. Date: Nov. 5, 2009

(54) SYSTEM AND METHOD FOR VIRTUAL BLOCKING OF NON-VOCAL MESSAGING SERVICES

(76) Inventor: Tracy J. Crowe, Julian, CA (US)

Correspondence Address: FRASER CLEMENS MARTIN & MILLER LLC, 28366 KENSINGTON LANE, PERRYSBURG, OH, 43551, US

(21) Appl. No.: 12/433,199

(22) Filed: Apr. 30, 2009

Related U.S. Application Data
(60) Provisional application No. 61/049,805, filed on May 2, 2008.

(51) Int. Cl. H04M 3/00

(52) U.S. Cl. 455/418

(57) ABSTRACT

A blocking system and a method for virtual blocking of SMS/MMS/EMS protocols based on vehicular and handset conditions are disclosed. One aspect of the invention is to virtually block the non-voice related messaging on a handset by disabling the display and keyboard. In one embodiment, a blocking module is installed on the handset and when conditions are met, the blocking module will disable the display and keyboard of the handset. Several parameters are monitored for determining whether the driver is engaged in driving the vehicle or is parked. Furthermore, the method and the blocking system are adapted to disable virtual blocking in times of emergency.

### CROSS-REFERENCE TO RELATED APPLICATION

This application claims the benefit of U.S. Provisional Patent Application No. 61/049,805 filed on May 2, 2008.

### FIELD OF THE INVENTION

The present invention relates in general to mobile communication systems. More particularly, the present invention relates to a blocking system and a method for effectively blocking the messaging services used for non-voice communications while a vehicle is in operation by a user of a mobile handset.

### BACKGROUND OF THE INVENTION

Mobile phones (handsets) typically provide various means for non-voice communications. While there are laws restricting and/or defining acceptable methods and systems for conducting voice communications while operating a motor vehicle, no legislation or systems have been deployed to govern non-vocal (e.g., text, multi-media, email) methods of communicating over a mobile handset. These methods are also known as Short-, Enhanced-, Multimedia Messaging Services (SMS, EMS, and MMS) and they use separate protocols from those used for voice communications.

Currently, there are brute force methods (e.g., wave disrupters—a.k.a. “jammers”) for completely blocking mobile phone communications but these have been outlawed in the United States and other countries.

It would be desirable to have a blocking system and a method for effectively blocking the messaging services used for non-voice communications while a vehicle is in operation by a user of a mobile handset.

### SUMMARY OF THE INVENTION

Concordant and consistent with the present invention, a blocking system and a method for effectively blocking the messaging services used for non-voice communications while a vehicle is in operation by a user of a mobile handset, has surprisingly been discovered.

In one embodiment, a blocking system comprises: a vehicle base station module for receiving a vehicle information signal, analyzing the vehicle information signal to determine a condition of a vehicle, and transmitting a blocking control signal in response to the determined condition of the vehicle; and an xMS vBlocking module in communication with the vehicle base station module and adapted to virtually block messaging services used for non-voice communications in response to the blocking control signal.

In another embodiment, a virtual blocking system comprises: a vehicle base station module for receiving a vehicle information signal, analyzing the vehicle information signal to determine a condition of a vehicle, and transmitting a blocking control signal in response to the condition of the vehicle; and an xMS vBlocking module in communication with the vehicle base station module and including a protocol analyzer adapted to receive and analyze a plurality of communication events to determine a particular protocol associated with each of the communication events, wherein the xMS vBlocking module is adapted to virtually block at least one of the communication events in response to at least one of the associated protocol and the blocking control signal.

The invention also provides methods for effectively blocking the messaging services used for non-voice communications.

One method comprises the steps of: integrating a blocking module with the handset, wherein the blocking module is adapted to virtually block at least one of a plurality of communication events received by the handset; installing a vehicle base station module into a vehicle, wherein the vehicle base station module receives a vehicle information signal, processes the vehicle information signal to determine a condition of a vehicle, and transmits a blocking control signal in response to the determined condition of the vehicle; linking the handset with the vehicle base station module; processing a plurality of communication events received by the handset; and activating a virtual blocking of the blocking module for selectively blocking at least one of the communication events in response to the processing of at least one of the vehicle information signal and the communication events.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a schematic block diagram of a blocking system according to an embodiment of the present invention;

FIG. 2 is a schematic block diagram of a xMS vBlocking module in communication with a handset according to an embodiment of the present invention; and

FIG. 3 is a flow chart of a method for effectively blocking the messaging services used for non-voice communications while a vehicle is in operation by a user of a mobile handset.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

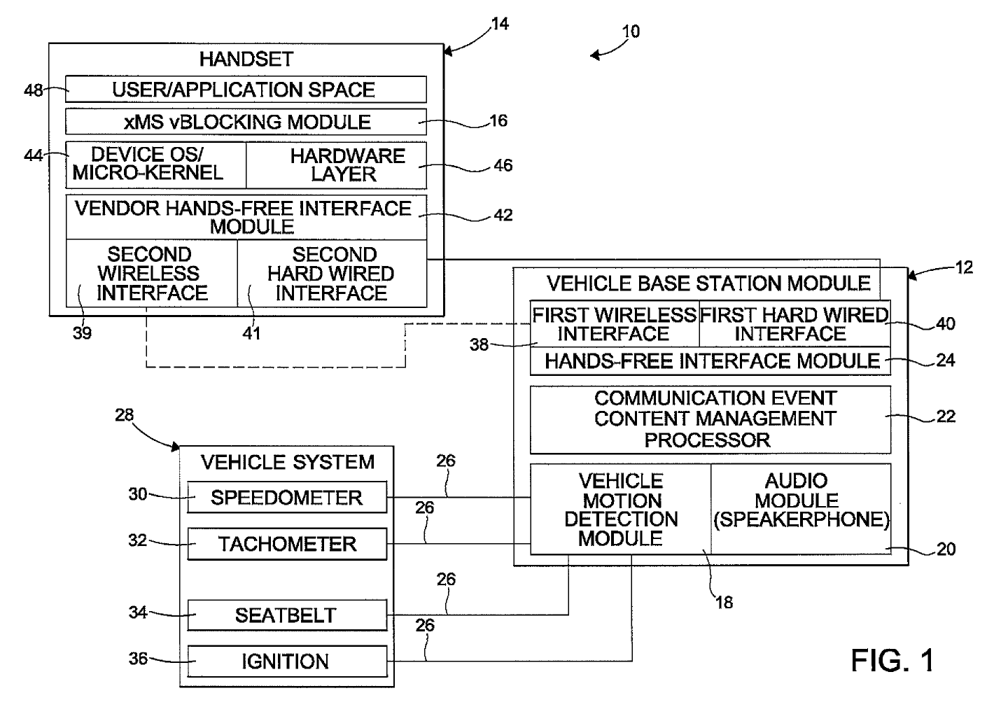

FIG. 1 shows a blocking system 10 according to an embodiment of the present invention. The blocking system 10 includes a Vehicle Base Station Module (VBSM) 12 and a handset 14 including an xMS vBlocking module 16, hereinafter referred to as the blocking module 16. The handset 14 may be any mobile device adapted to receive the blocking module 16, such as a mobile phone capable of text messaging using SMS/MMS/EMS protocols for messaging, for example. It is understood that the blocking module 16 may be integrated with the handset 14 during a vendor manufacturing process or a post manufacturing installation process.

As shown, the VBSM 12 includes a vehicle motion detection module 18, an audio module 20, a communication event content management processor 22, hereinafter referred to as the content management processor 22, and a hands-free interface module 24. The vehicle motion detection module 18 is adapted to receive vehicle information signals 26 from at least one of the handset 14 and a vehicle system 28 to determine a vehicle condition such as the vehicle's motion status, for example. As a non-limiting example, the vehicle information signals 26 may include data or information representing the status of a global positioning system (not shown), a speedometer 30, a tachometer 32, a seatbelt sensor 34, and an ignition system 36. It is understood that the vehicle information signals 26 may include other vehicle information or data, as desired. Although the vehicle motion detection module 18 is shown receiving information from four vehicle systems 28, it is understood that any number of vehicle systems 28 and sensors may be used, as desired.

The audio module 20 is adapted to transmit an audible output to a user. The audio module 20 is in communication with the content management processor 22 and adapted to receive an audio signal from the content management processor 22. The audio module 20 may be any device capable of receiving the audio signal and transmitting the audible output in response to the audio signal such as a loudspeaker, for example.

The content management processor 22 is adapted to receive an input signal from the hands-free interface module 24, analyze the input signal, and transmit the audio signal to the audio module 20 in response to the input signal. The content management processor 22 is also adapted to communicate with the vehicle motion detection module 18 and transmit a blocking control signal to the blocking module 16 in response to a vehicle condition. As a non-limiting example, the content management processor 22 analyzes the received input signals based upon a pre-programmed instruction set. As a further example, the functions of the content management processor 22 may be programmable after the blocking system 10 is properly installed.

The hands-free interface module 24 is adapted to link with the handset 14 and receive the input signal from the handset 14. As shown, the hands-free interface module 24 is adapted to link with the handset 14 by at least one of a first wireless interface 38 and a first hard wired interface 40. As a non-limiting example, the first wireless interface 38 is a Bluetooth® compatible interface. However, it is understood that other means for linking the hands-free interface module 24 to the handset 14 may be used, as appropriate.

As shown, the handset 14 includes a vendor interface module 42, an operating system 44, a hardware layer 46, an application space 48, and the integrated blocking module 16. It is understood that the handset 14 may include additional features including hardware and software such as a global positioning system and associated utilities, for example. The vendor interface module 42 is adapted to link with the hands-free interface module 24 of the VBSM 12 by at least one of a second wireless interface 39 and a second hard wired interface 41. As a non-limiting example, the second wireless interface 38 is a Bluetooth® compatible interface. It is understood that the vendor interface module 42 may be adapted to link to other interface modules, as desired. It is further understood that other means for linking the vendor interface module 42 to the hands-free interface module 24 may be used, as appropriate. The vender interface module 42 may be installed during a vendor manufacturing process of the handset 14. The vendor interface module 42 may also be installed in a post manufacturing process, as desired.

The operating system 44 of the handset 14 may be any operating system 44 adapted to control and manage the hardware, software, and processing of the handset 14. Other management devices such as a micro-kernel may be used, as desired. The hardware layer 46 includes the hardware features for a particular handset 14 model. It is understood that mobile handset models have various pre-configured hardware features such as memory devices, photographic devices, and video and audio devices, for example. It is further understood that any number of hardware features may be included or added, as desired.

The application space 48 includes a memory for storing user applications, data, and software to the handset 14. In certain embodiments, the application space 48 is interconnected with the operating system 44 for the management of the user applications, data, and software stored on the handset 14.

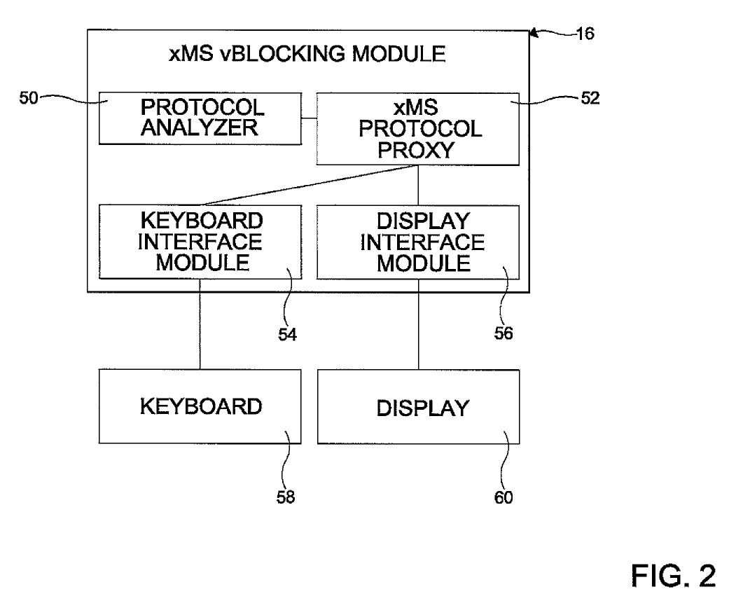

As more clearly shown in FIG. 2, the blocking module 16 includes a protocol analyzer 50, a protocol proxy 52, a keyboard interface module 54, and a display interface module 56. In general, the blocking module 16 monitors an incoming communication event received by the handset 14 to determine the communication protocols that are being used during the communication event. As a non-limiting example, the communication event may be a voice call or a text message. Other communication events may be received by the handset 14 such as e-mail and MMS, for example. Once the protocols are determined, the blocking module 16 communicates with the handset 14 and the VBSM 12 to manage the communication event appropriately.

Specifically, the protocol analyzer 50 is adapted to process and analyze a plurality of protocols to determine a particular protocol of a specific communication event. It is understood that the protocol analyzer 50 may be adapted to detect any communication event protocol such as SMS, EMS, MMS, and various voice protocols, for example.

The protocol proxy 52 is adapted to communicate with other modules within the handset 14 to manage resources and ensure a timely response is given to the various components and modules of the handset 14 to prevent a false error state from occurring.

The keyboard interface module 54 and the display interface module 56 are designed to interconnect and communicate with existing modules within the handset 14 for controlling a keyboard 58 and a display 60 associated with the handset 14. Specifically, the keyboard interface module 54 controls handset keyboard locking/unlocking and the display interface module 56 controls handset display commands, such as, ‘sleep’ or ‘invoke screensaver’, for example.

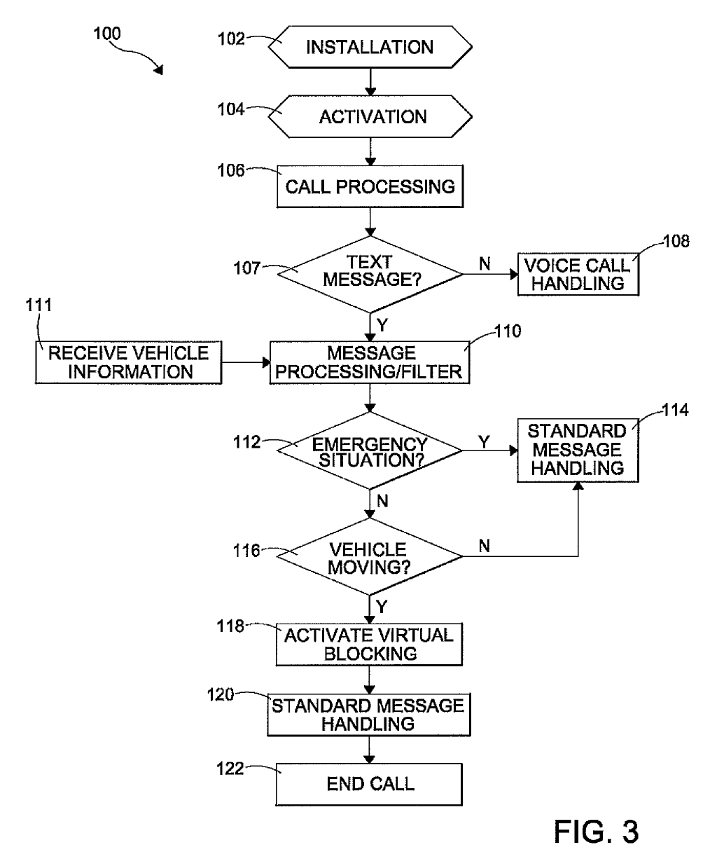

FIG. 3 shows a process flow 100 from the installation of the VBSM 12 and the blocking module 16 to the processing of the communications events by the blocking system 10. In step 102, the blocking module 16 is integrated with the handset 14 and the VBSM 12 is installed in a vehicle. The blocking module 16 may be loaded onto the handset 14 via Over-The-Air (OTA) download or a direct connection with a PC. Other methods of loading the blocking module 16 may be used such as a hardware installation, for example. Once installed, the blocking module 16 leverages the pre-installed, vendor provided software for managing voice calls through a hands-free kit or headset. The blocking module 16 goes beyond the vendor software to further link into the handset keyboard and handset display as part of its “virtual blocking”. The term “virtual blocking” is used to indicate that no active transmitting devices (e.g., wave disrupters, jammers, scramblers, etc.) are used and the received messages are stored on the handset. Only the visual and audible alerts and interfaces to those messages are disrupted.

In step 104, the handset 14 including the integrated blocking module 16 is linked to the VBSM 12 through the connection formed between the vendor interface module 42 and the hands-free interface module 24.

Once the handset 14 is linked with the VBSM 12, the blocking module 16 interacts through the connection to the VBSM 12 for instructions to enable or disable “virtual blocking” in response to the communication events, as shown in step 106. Specifically, the blocking device 16 and the VBSM 12 are designed to use pre-installed, pre-tested tools and methodologies for communicating with each other. More specifically, the blocking device 16 and the VBSM 12 utilize at least one of a wireless protocol and a hard wired connection to create a PAN (Personal Area Network) therebetween. It is understood that the handset 14 is adapted to detect and modify processing when the presence of a headset or other hands-free device is detected by the handset 14.

In step 107, the content manager processor 22 determines the protocol of the communication event. Where the communication event received by the handset 14 is a voice call, the VBSM 12 instructs the blocking module 16 to allow the handset 14 to handle it as a normal voice call, as shown in step 108. In certain embodiments, the VBSM 12 also includes the integrated audio module 20, thereby providing a hands-free device for voice calls. Where the communication event is a text message, the process flow 100 is directed to step 110.

In step 110, the content management processor 22, in cooperation with the vehicle motion detection module 18, receives vehicle information 111 for determining whether the vehicle or driver is in an emergency situation, whether the vehicle has the ignition turned on (engine start/running), whether there is a driver present in the vehicle (using seat sensors or seatbelt sensors), and, after receiving a combination of inputs from the tachometer 32 and the speedometer 30, whether the vehicle is parked, idling in traffic, or being driven. It is understood that the control algorithms and instruction sets of the vehicle motion detection module 18 and content management processor 22 are leveraged to determine the vehicle state.

In step 112, the content management processor 22, in cooperation with the vehicle motion detection module 18, determines if the vehicle or driver is in an emergency situation. It is understood that the determination of an emergency situation may be in response to various vehicle information signals 26 or a driver-supplied emergency signal. Other methods for determining an emergency situation may be used, as desired. Where an emergency situation is found, all virtual blocking is disabled and the process flow 100 is directed to 114 for standard message handling. Otherwise, the process flow 100 is directed to step 116.

In step 116, the content management processor 22, in cooperation with the vehicle motion detection module 18, determines if the vehicle is moving. Where the vehicle is determined to be moving, the process flow 100 is directed to step 118. Otherwise, all virtual blocking is disabled and the process flow 100 is directed to 114 for standard messaging handling.

In step 118, the VBSM 12 communicates with the blocking module 16 to activate the virtual blocking of particular communication events, such as text messages, for example. Specifically, the content management processor 22 transmits the blocking control signal to the blocking module 16 for activation of virtual blocking. During the virtual blocking of step 118, the blocking module 16 may disable the keyboard and the display of the handset 14. It is understood that the protocol proxy 52 of the blocking module 16 communicates with other components and modules of the handset 14 to ensure proper functioning of the handset 14, while militating against any false error states. The process flow 100 is then directed to step 120 for standard message handling of other communication events until the call is ended in step 122.

The blocking system 10 and the method for blocking the messaging services used for non-voice communications while a vehicle is in operation by the user of the mobile handset 14 includes a combination of software and hardware for disabling the display screen and keyboard of the handset 14 without relying on jamming or scrambling.

Additionally, the blocking system 10 receives vehicle information from the vehicle systems 28 to automatically determine in real time when to enable or disable virtual blocking. The blocking system 10 further includes an emergency override that immediately disables virtual blocking if the vehicle or the operator is deemed to be in an emergency situation.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A blocking system comprising:
a vehicle base station module for receiving a vehicle information signal, analyzing the vehicle information signal to determine a condition of a vehicle, and transmitting a blocking control signal in response to the determined condition of the vehicle; and
an xMS vBlocking module in communication with the vehicle base station module and adapted to virtually block messaging services used for non-voice communications in response to the blocking control signal.

2. The blocking system according to claim 1, wherein the vehicle information signal represents the status of at least one of a speedometer, a tachometer, a seatbelt sensor, and an ignition system.

3. The blocking system according to claim 1, wherein the vehicle base station module includes an audio module adapted to transmit an audible output for hands-free voice communication.

4. The blocking system according to claim 1, wherein the xMS vBlocking module is interconnected with the vehicle base station module through at least one of a hard wired interface and a wireless interface.

5. The blocking system according to claim 1, wherein the xMS vBlocking module is integrated with a mobile handset.

6. The blocking system according to claim 5, wherein the handset includes at least one of a keyboard and a display, and wherein the xMS vBlocking module is adapted to disable at least one of the keyboard and the display in response to the blocking control signal.

7. A virtual blocking system comprising:
a vehicle base station module for receiving a vehicle information signal, analyzing the vehicle information signal to determine a condition of a vehicle, and transmitting a blocking control signal in response to the condition of the vehicle; and
an xMS vBlocking module in communication with the vehicle base station module and including a protocol analyzer adapted to receive and analyze a plurality of communication events to determine a particular protocol associated with each of the communication events, wherein the xMS vBlocking module is adapted to virtually block at least one of the communication events in response to at least one of the associated protocol and the blocking control signal.

8. The blocking system according to claim 7, wherein the vehicle information signal represents the status of at least one of a speedometer, a tachometer, a seatbelt sensor, and an ignition system.

9. The blocking system according to claim 7, wherein the vehicle base station module includes an audio module adapted to transmit an audible output for hands-free voice communication.

10. The blocking system according to claim 7, wherein the xMS vBlocking module is interconnected with the vehicle base station module through at least one of a hard wired interface and a wireless interface.

11. The blocking system according to claim 7, wherein the xMS vBlocking module is integrated with a mobile handset.

12. The blocking system, according to claim 11, wherein the handset includes at least one of a keyboard and a display, and wherein the xMS vBlocking module is adapted to disable at least one of the keyboard and the display in response to the blocking control signal.

13. A method for effectively blocking a messaging service used for non-voice communications the method comprising the steps of:
integrating a blocking module with the handset, wherein the blocking module is adapted to virtually block at least one of a plurality of communication events received by the handset;
installing a vehicle base station module into a vehicle, wherein the vehicle base station module receives a vehicle information signal, processes the vehicle information signal to determine a condition of a vehicle, and transmits a blocking control signal in response to the determined condition of the vehicle;
linking the handset with the vehicle base station module;
processing a plurality of communication events received by the handset; and
activating a virtual blocking of the blocking module for selectively blocking at least one of the communication events in response to the processing of at least one of the vehicle information signal and the communication events.

14. The method according to claim 13, wherein the vehicle information signal represents the status of at least one of a speedometer, a tachometer, a seatbelt sensor, and an ignition system.

15. The method according to claim 13, wherein the vehicle base station module includes an audio module adapted to transmit an audible output for hands-free voice communication.

16. The method according to claim 13, wherein the handset is interconnected with the vehicle base station module through at least one of a hard wired interface and a wireless interface.

17. The method according to claim 13, wherein the handset includes at least one of a keyboard and a display, and wherein the blocking module is adapted to disable at least one of the keyboard and the display in response to the processing of vehicle information and communication events.

18. The method according to claim 13, wherein the blocking module includes a protocol analyzer adapted to receive and analyze a plurality of communication events to determine a particular protocol associated with each of the communication events.

19. The method according to claim 13, wherein the processing of the vehicle information signals includes at least one of: determining a motion of the vehicle; determining an emergency situation of the user; and determining an emergency situation of the vehicle.

20. The method according to claim 13, wherein the processing of the communication events includes determining a protocol associated with each of the communication events.
